(19) United States
(12) Patent Application Publication
(10) Pub. No.: US 2014/0021231 A1
(43) Pub. Date: Jan. 23, 2014

(54) bicycle U-lock carrier

(71) Applicant: Deborah Lynn Riat, San Francisco, CA (US)

(72) Inventor: Deborah Lynn Riat, San Francisco, CA (US)

(21) Appl. No.: 13/927,423

(22) Filed: Jun. 26, 2013

Related U.S. Application Data
(60) Provisional application No. 61/666,305, filed on Jun. 29, 2012.

(51) Int. Cl. B62J 11/00

(52) U.S. Cl. CPC B62J 11/00
USPC 224/412

(57) ABSTRACT

The present invention is a bicycle U-lock carrier which provides a lightweight, convenient way for a bicycle rider to carry or store a bicycle U-lock attached to a bicycle.

### FIELD OF THE INVENTION

The present invention relates to bicycle U-locks and bicycles and more particularly, to a way to securely attach a bicycle U-lock to a bicycle for the purpose of transporting the bicycle U-lock or storing the bicycle U-lock.

### BRIEF DESCRIPTION OF DRAWINGS

FIG. 1. shows a bicycle U lock 60 and it's three components, the U bar 61 which detaches from the lock bar 62 via a key lock 63.

FIG. 2. is an application drawing showing the two components of the bicycle U lock carrier 100; the U bar carrier 110 attached to the bicycle frame top tube 51 and the lock bar carrier 120 attached to the bicycle frame seat post tube 52 under the bicycle seat 50.

FIG. 3. is a perspective view of the U bar carrier 110 showing the U bar carrier sleeve 111 which slides over the U bar 61 and two cloth flaps, the U bar carrier flap with velcro hooks 113 and the U bar carrier flap with velcro loops 112 that secure the U bar 61 to the bicycle frame top tube 51.

FIG. 4. is a perspective view of the lock bar carrier 120 showing the lock bar earner sleeve 121 which slides over the lock bar 62 and two cloth flaps, the lock bar carrier flap with velcro hooks 123 and the lock bar carrier flap with velcro loops 122 that secure the lock bar 62 to the bicycle frame seat post tube 52. The key lock 63 on the lock bar 62 is accessed by the key access opening 124.

### DETAILED DESCRIPTION OF THE PREFERRED EMBODIMENTS

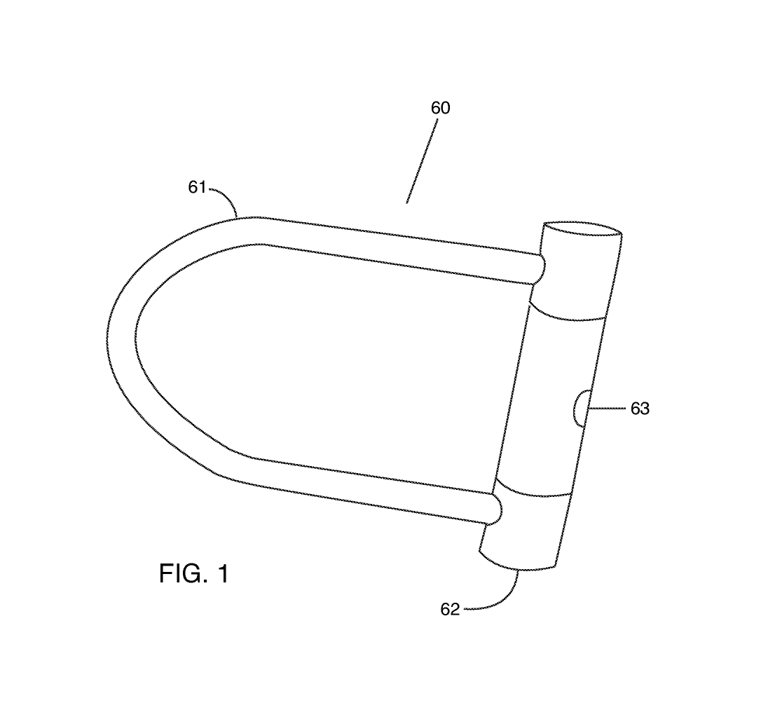

Referring to FIG. 1 which depicts one embodiment of a conventional bicycle U-lock. The U-lock 60 consists of a U-bar 61 and a lock-bar 62. The lock-bar 62 houses a key-lock 63.

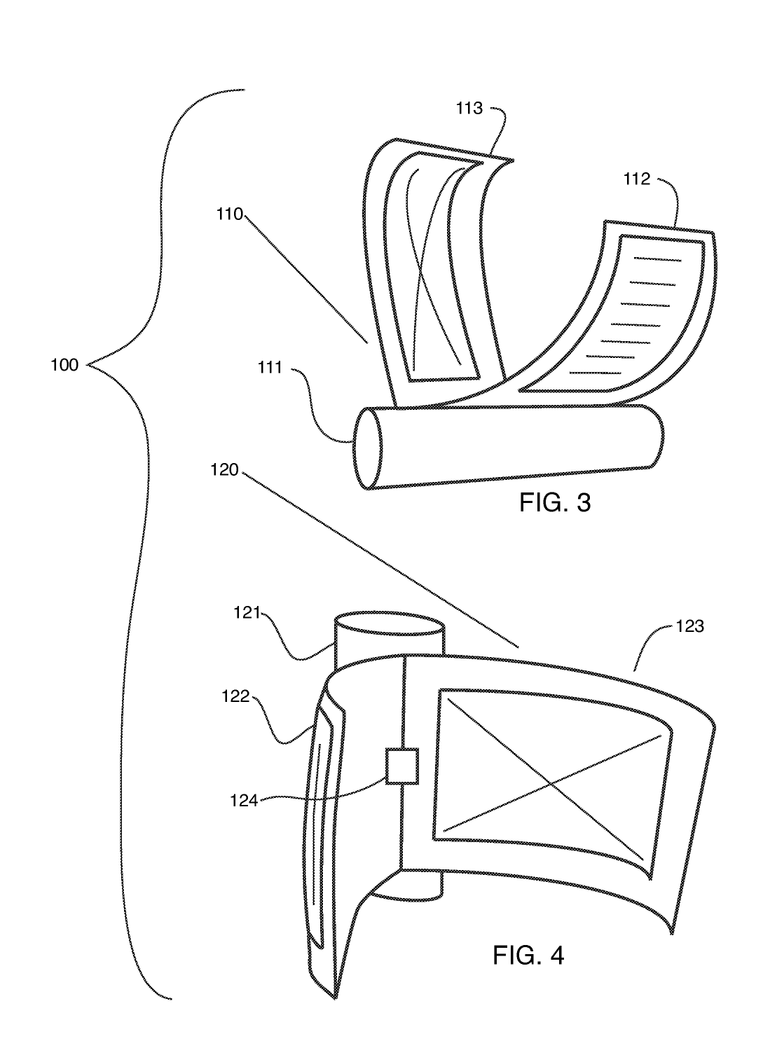

Referring to FIG. 3 and FIG. 4, which together depict the invention the bicycle U-lock carrier 100. There are two unattached parts that make up the bicycle U-lock carrier 100. The two unattached parts that make up the bicycle U-lock carrier 100 are the U-bar carrier 110 and the lock-bar carrier 120.

Referring to HG. 3 which depicts the U-bar carrier 110. The U-bar carrier 110 has three functional parts. The U-bar carrier 110 consists of the U-bar carrier sleeve 111, the U-bar carrier flap with velcro loops 112, and the U-bar carrier flap with velcro hooks 113. Referring to FIG. 4 which depicts the lock-bar carrier 120. The lock-bar carrier has three functional parts. The lock-bar carrier sleeve 121, the lock-bar carrier flap with velcro loops 122, and the lock-bar carrier flap with velcro hooks 123. The lock-bar carrier 120 also has a hole, which is referred to as the key access opening 124 to accommodate access for the lock key to fit into the lock bar 62 key lock 63.

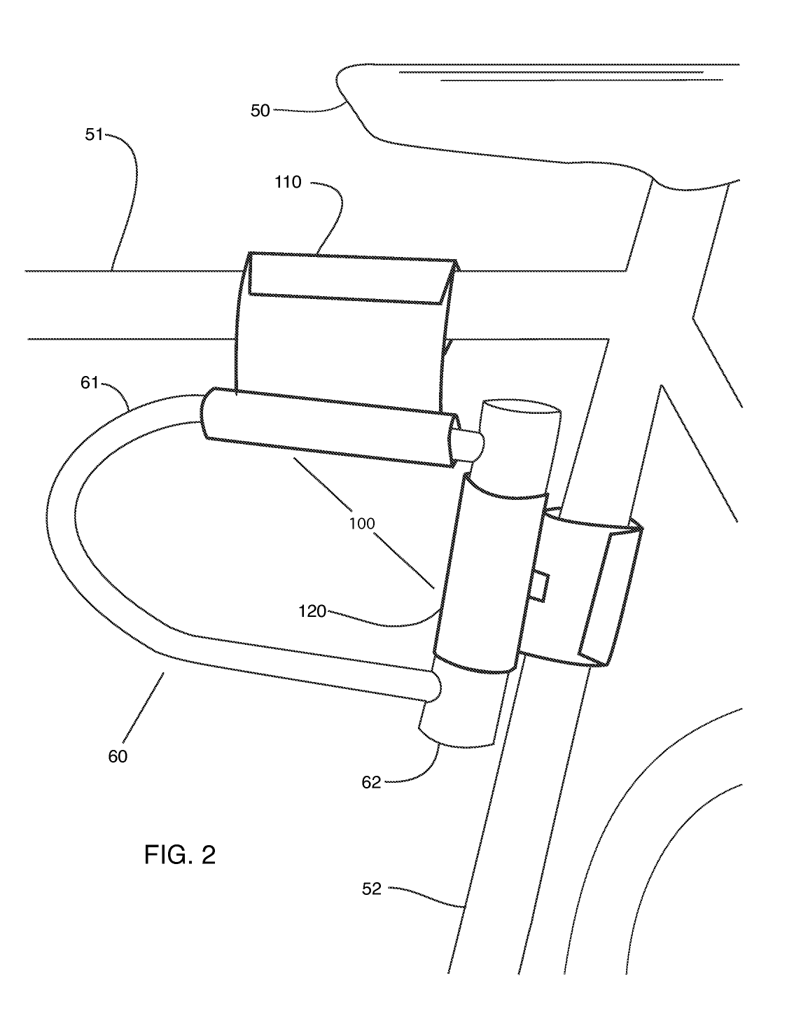

FIG. 2 depicts the U-lock 60 with both parts of the U-lock carrier 100 installed on the U-lock 60. FIG. 2 depicts the U-lock 60 with both parts of the U-lock carrier 100 installed on the U-lock 60 and also depicts both parts of the U-lock carrier 100 attached to the bicycle frame top tube 51 and the bicycle frame seat post tube 52.

FIG. 2 depicts the U-lock U-bar 61 inserted through the U-bar carrier sleeve 111. FIG. 2 depicts the U bar carrier flap with velcro loops 112 wrapped around the bicycle frame top tube 51. FIG. 2 depicts the U bar carrier flap with velcro hooks 113 wrapped over the U bar carrier flap with velcro loops 112 in order to engage the velcro for the purpose of securing the U-lock 60 U-bar 61 to the bicycle frame top tube 51.

FIG. 2 depicts the U-lock lock-bar 62 inserted through the lock-bar carrier sleeve 121. FIG. 2 depicts the lock-bar carrier flap with velcro loops 122 wrapped around the bicycle frame seat post tube 52, HG. 2 depicts the lock-bar carrier flap with velcro hooks 123 wrapped over the lock-bar carrier flap with velcro loops 122 in order to engage the velcro for the purpose of securing the U-lock 60 lock-bar 62 to the bicycle frame seat post tube 52.

1. A constructed fabric device for attaching, carrying and storing a bicycle U-lock on a bicycle frame consisting of:
a) a constructed fabric device used to secure the locking tube mechanism of a bicycle U-lock to the bicycle seat vertical tube of a bicycle, and
b) a constructed fabric device used to secure the curved portion of a bicycle U-lock to the top horizontal tube of a bicycle.
